(19) United States
(12) Patent Application Publication
(10) Pub. No.: US 2004/0022947 A1
(43) Pub. Date: Feb. 5, 2004

(54) Method for creating microstructure patterns by contact transfer technique

(76) Inventors: Michael T. Duignan, Washington, DC (US); Scott A. Mathews, Germantown, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/208,802

(22) Filed: Aug. 1, 2002

(51) Int. Cl. B05D 3/00; B23K 26/00

(52) U.S. Cl. 427/271; 427/555

(57) ABSTRACT

A method of creating microstructures by contact transfer process includes the step of positioning a material covered ribbon in proximity with the surface of the substrate, directing a laser beam onto the material covered ribbon, so that the laser beam releases a portion of the material layer and transfers the released material onto the surface of the substrate. The material covered ribbon includes a transparent support and a material layer of the thickness in the range of 2-15 microns of highly homogeneous and uniformly distributed material, which includes a powder of very small particles the dimensions of which do not exceed 10 microns bound by a binder which provides a needed degree of viscosity to the material, which, being released from the material layer, is transferred to the surface of the substrate as a single piece. In order to create a microstructure, several repetitions of releasing the material and transferring the released material to the substrate is needed. Very fine features with no edge irregularities are created by this method.

### FIELD OF THE INVENTION

The present invention relates to manufacture of microstructures on substrates; and more particularly, to the process of creating microstructure patterns by means of a contact transfer technique.

More in particular, the present invention relates to a contact transfer process for creation of microstructure patterns in which a laser beam impinges upon a predefined area of a material covered ribbon in order to release and transfer the material therefrom onto a surface of a substrate thus forming microstructures of desired shapes and dimensions on the predefined area of the substrate.

Further, the present invention relates to a contact transfer process for creation of fine and sharply edged microstructures achieved by: (a) a specific relative disposition between the material covered ribbon and the substrate; (b) by controlling the properties of material layer of the material covered ribbon; and, (c) by controlling and structuring the laser beam in a specific predefined manner.

The present invention further relates to a contact transfer technique using a material covered ribbon in which the material layer is formed of a specifically formulated composition, including particles of a predefined size, and further in which uniformity of the material layer as well as thickness thereof is controlled for improving the resolution and sharpness of microstructures created on the surface of the substrate.

### BACKGROUND OF THE INVENTION

To create microstructures, matrix assisted pulse laser evaporation (MAPLE-DW) was previously proposed in accordance with a principle wherein a transparent support covered with a material is positioned at a known distance from a substrate on the surface of which the microstructure is to be formed and a laser beam impinges upon the material through the transparent support. When the material is “energized” by the laser beam at the interface between the transparent support and the material, a volume element of the material primarily defmed by the size and shape of the laser spot as well as the thickness of the material layer, is propelled from the surface of the support. The object was to transfer the ablated material on the surface of the substrate for deposition thereon in order to form a microstructure. However, the principles of the MAPLE-DW technique have failed to attain the formation of fine and sharply edged microstructures. With MAPLE-DW, the achievable resolution degrades with increasing spacing between the “ribbon” and substrate. However, limitations on ribbon and substrate flatness as well as practical issues involved in moving the ribbon laterally with regard to the substrate require increasing the ribbon-substrate gap, thereby limiting minimum feature size to ˜50 μm.

Details of the process, such as the relative disposition between the material covered ribbon and the substrate, specifics of material layer of the material covered ribbon, characteristics of the laser beam, etc., which could overcome the limitations of the process were not known in the previous of the MAPLE-DW technique and were not explicitly studied and thus it was impossible to obtain high quality, sharply edged microstructures.

Therefore, in order to obtain high quality microstructures, it is highly desirable to design a technique using specific technological parameters of the process which permits creation of fme and sharply edged microstructures.

### SUMMARY OF THE INVENTION

It is therefore an object of the present invention to provide a transfer technique for creation of microstructure patterns where the essential technological characteristics are determined and controlled in order to create high resolution microstructure patterns on the surface of a substrate.

It is another object of the present invention to provide a transfer technique for creation of high resolution microstructures in which a material covered ribbon is positioned in contiguous contact with the surface of the substrate in order to achieve material contact transfer. Additionally, the thickness and composition of the material layer of the material covered ribbon is determined and controlled in a specific manner. Still further, the subject invention relies on a laser beam which is structured in a manner to obtain fmely and sharply edged microstructures of optimal qualities.

It is a further object of the present invention to provide a transfer process using a material covered ribbon in which the thickness of the material layer is greater than 1 μm and does not exceed 25 μm and where a binder is used to form material of needed characteristics.

In accordance with the principles of the present invention, a material covered ribbon containing a material layer deposited on a substantially transparent flexible support is positioned in contiguous contact with the surface of the substrate upon which the microstructures are to be created. A laser beam of a controlled shape and intensity is directed towards the material covered ribbon. The laser beam passes through the optically transparent support thereof and impinges upon the material layer at a predefined area. A small fraction of the material affected by the laser beam energy vaporizes at the interface with the transparent support of the material covered ribbon and is deposited onto the surface of the substrate in a predetermined area, thus forming a portion of a microstructure to be created.

Further, either by moving the laser beam, and/or the ribbon and substrate, the relative positions are changed in order to direct the laser beam onto a “fresh” (non-released) area of the material layer of the material covered ribbon which releases the material therefrom and deposits the released material onto the substrate. In order to form high quality microstructures, the displacement of the laser beam is controlled in a manner such that the next deposited portion of the material is deposited onto the substrate in adjacent fashion with the previously deposited portion of the material.

The material covered ribbon is designed with the material layer of particular quality. Initially, it is important that the thickness of the material layer does not exceed the range of 25 μm microns and the deviation of the uniformity of the thickness does not exceed 10% over the entire area of the material layer. Further, it is important that the largest material particles themselves are small compared to the minimum desired feature size (generally smaller than 10 μm). The particles are distributed in a highly homogeneous fashion. Broad distribution of particle size, down to 100 nm or smaller permits more densely packed material and is, therefore, generally desirable. The material avoids the spreading of particles between the ribbon and the substrate and is cohesive in order to transfer the material covered ribbon to the surface of the substrate in a cohesive manner.

Simultaneously, the material does not adhere to the back side of the ribbon when the material covered ribbon is rolled. Stability of the material is important during a shipping process in order that the state does not change.

All the required features of the material have been attained by forming the material layer of the material covered ribbon with a powder having the material particles of dimensions not exceeding 10 μm microns in diameter bound by a binder such as, for example, styrene alyl alcohol which provides a non-sticky, flexible material. When the material used is silver, the material layer is formed with a precursor such as silver trifluoroacetate which yields silver when decomposed. During transfer, the particles of the silver powder do not spread since they are held each to the other by the binder and are deposited onto the surface of the substrate in a cohesive manner to form a microstructure.

It has been found that in order to obtain high quality microstructures, several successive, superimposed transfers of the material may be needed. In each transfer a “fresh” area of the material layer is positioned over the substrate in precise alignment with the area of the substrate whereon the fine microstructure is to be created. During repetitive laser “scans”, the laser impinges upon the material layer to create an overlapping of the edges of each transferred portion of the material.

After the transfers are completed, the deposited material is processed or cured, often by baking, to remove the organic binder therefrom, and to convert the precursor. Only the desired phase of the material is left on the surface of the substrate.

During the contact transfer process, the substrate may be heated, for example, to a specific temperature (varying according to the material), which makes the material transferred to the substrate somewhat softer, thus improving the transfer and deposition process.

It is an important feature of the present invention that the laser beam has a controlled intensity and cross-sectional shape. The shape or contour and size of the laser beam cross-section is dictated by the geometry of the microstructure to be formed. Uniform distribution of the intensity of the laser flux is important for uniform ablation of the material from the material covered ribbon. The control of the distribution of the intensity of the laser beam, as well as of the shape and size thereof is carried out by means of an optical system which includes a dynamic aperture as well as a system of lenses and mirrors.

These and other novel features and advantages of the subject invention will be more fully understood from the following detailed description of the accompanying drawings.

### BRIEF DESCRIPTION OF THE DRAWINGS

FIG. 1 is a schematic drawing showing the simplified representation of the system for creating microstructures by the contact transfer process of the present invention;

FIGS. 2A-2D represent schematically the sequence of the operational steps of the method of the present invention;

FIG. 3 shows a roll type ribbon used in the contact transfer process of the present invention; and,

FIG. 4 is a flow chart diagram of the software for controlling the relative disposition between the laser beam and the substrate during the transfer process of the present invention.

### DETAILED DESCRIPTION OF THE PREFERRED EMBODIMENT

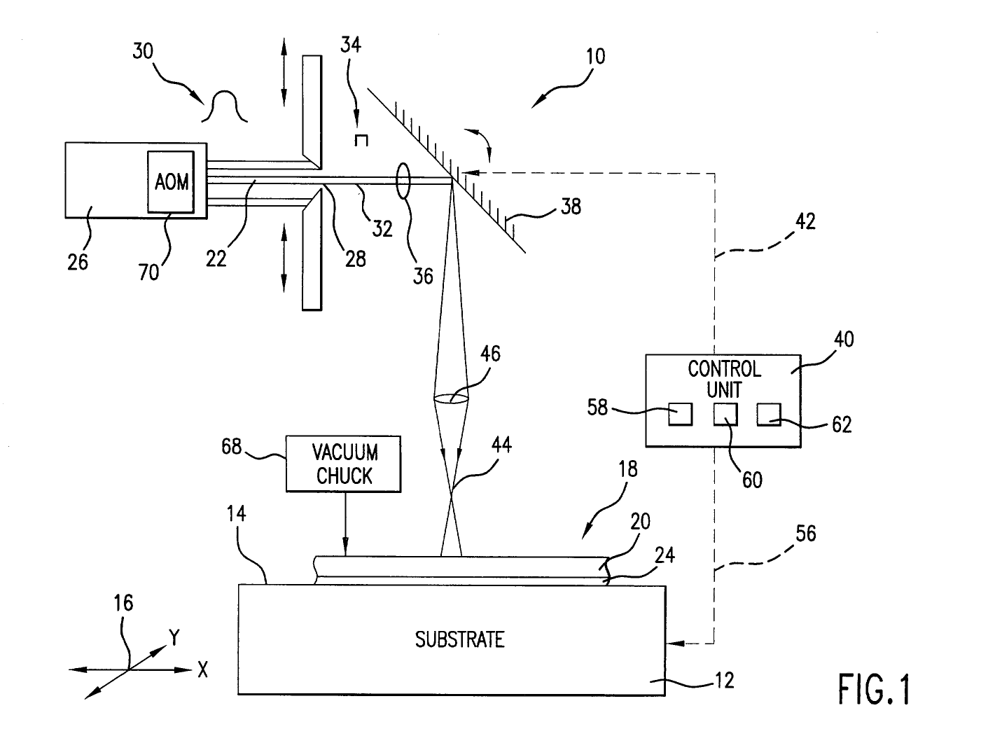

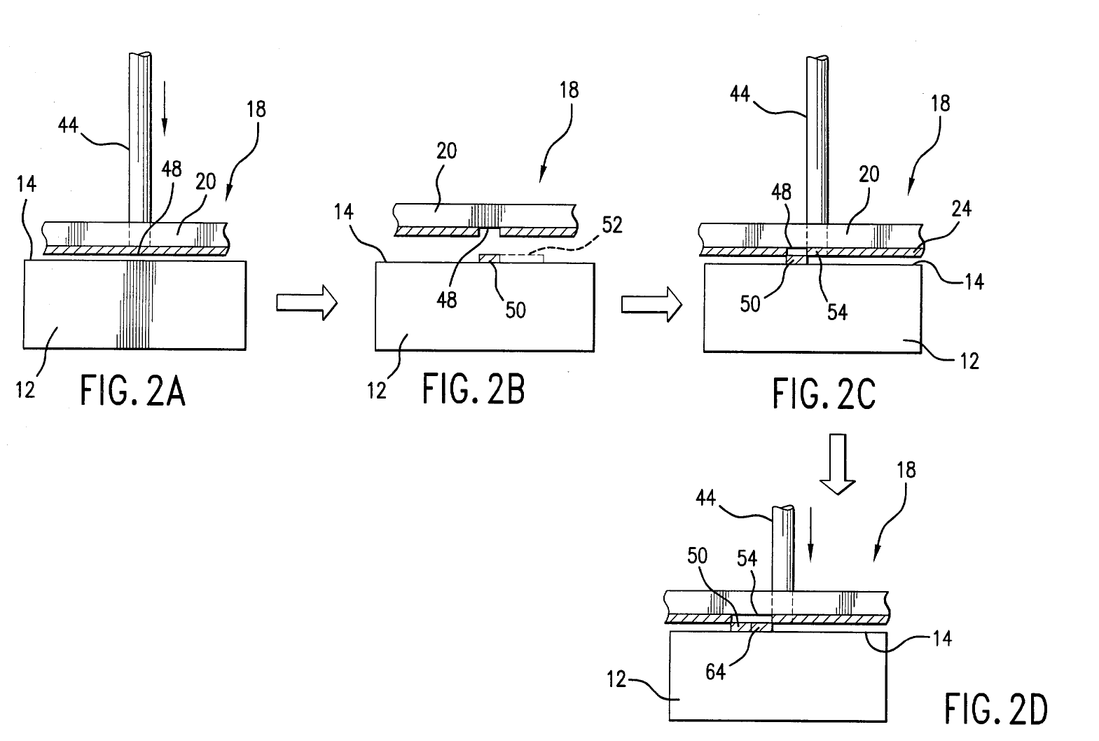

Referring to FIGS. 1 and 2A-2D, such depicts the contact transfer process of the present invention in a system 10. A substrate 12 on the surface 14 of which a microstructure pattern is to be created may be positioned onto a translational stage (not shown) capable of moving in X-Y directions 16. Translation stage is required if an area greater than the field size of the scanner is to be patterned. A material covered ribbon 18 is placed on the top of the substrate 12 in contiguous contact with the surface 14 thereof. The material covered ribbon 18 includes a flexible transparent support 20 which is transparent to the laser beam 22 and a material layer 24 that has been deposited onto the transparent support 20. The material layer 24 includes the material which is to be deposited onto the surface 14 of the substrate 12 where the features and characteristics thereof are discussed in following paragraphs.

Laser 26 emits the laser beam 22 of an intensity predefined by performance characteristics of the laser 26. For the purpose of the present invention, a wide variety of lasers may be used, for example, frequency tripled Nd laser, solid-state diode pumped laser, etc. Pulse widths less than a few hundred nanoseconds (for example, less than 250 ns) help to assure that thermal energy does not create a heat affected zone (HAZ) before the transfer event. Minimizing the HAZ helps to insure that the lateral dimension of the transferred material is approximately equal to that of the transfer laser spot size.

The optimal laser fluence is determined by the nature of the material to be transferred (including its thickness, consistency, absorptivity at the transfer laser wavelength, volatiles content, etc.). When the fluence is too low, transfers are inconsistent or fail to occur. When the fluence is too high, the transferred material may be dispersed or perforated by the surplus laser energy. Most transfers made in accordance with the principles of the present invention use fluences in the range of ˜0.1-2 J/cm² pulse.

Laser wavelengths below ˜400 nm and above ˜300 nm are generally most useful for transfer events. Light at longer wavelengths may not be readily absorbed by the material/matrix without additives that might affect final material properties. Light in the shorter wavelength side of the aforementioned range tends to be absorbed by common plastic ribbon-backing material which dictates use of exotic or expensive substitutes. Frequency tripled neodynium lasers, such as Nd:YLF or Nd-Vanadate operating at near 355 nm, are ideal in that they offer high average power, high repetition rates (currently ˜15-150 kHz repetition rates are typical) which may ultimately limit writing rates, and are readily commercially available.

As an example, and without limiting the scope of the present invention, a 355 nanometer frequency triple Nd:vanadate laser has been used for its high power and repetition rate capability. The generated laser beam 22 passes through the aperture 28 which patterns the laser beam in a manner to cut off a peripheral portion of the flux of the laser beam 22 and shapes the cross-section of the laser beam as dictated by the geometry of the microstructure to be created which may be typically round or rectangular.

A “top-hat” uniform intensity profile is desired to achieve best line uniformity and sharpest edges where the beam shape is generally circular or rectangular. A circularly shaped beam is generally preferred if all line segments to be deposited are not orthogonal. Particularly, as known to those skilled in the art, the laser beam 22 exiting the laser 26 has an intensity distribution across the diameter of the cross-section thereof as depicted by element 30 of FIG. 1. As shown, the intensity of the flux of the laser beam is maximized in the center and lower portions at the peripheral edges thereof. Thus, the aperture 28 cuts off the peripheral portions of the lower intensity of the laser beam 22, maintaining the portion 32 thereof having a substantially uniform distribution of the intensity across the cross-section, as depicted by element 34 of FIG. 1.

Thus, structured laser beam, having a uniform distribution of the intensity may be directed towards a lens 36 (optional), or alternatively, is directed to a mirror 38 which is controlled by a control unit 40 over the control channel 42 which alters the position of the mirror 38 in order to control the direction of the laser beam portion 44 relative to the material covered ribbon 18 and the substrate 12.

The mirror 38 may be a galvanometer type mirror operating with a telecentric or f-θ lens. The system provides for laser beam impact onto the substrate in a perpendicular direction to the substrate surface plane. This type of system is well-known to those skilled in the art and therefore is not described in further detail.

A laser beam can be accelerated and scanned at much higher rates than a substrate on physical stages, therefore displacing the beam is often preferred to moving the substrate. A system with galvanometric (also known as galvo) mirrors (as opposed to polygon scanning mirrors) under computer control is also preferred—especially when the coverage density of the deposited material is low or when the “write” rate is limited by available laser repetition rates.

The laser beam portion 44 reflected from the mirror 38 passes through the lens 46 for advantageous focusing thereof and impinges upon the material covered ribbon 18 in a predetermined area. Since the support 20 is transparent to the laser radiation, the laser beam portion 44 passes through the transparent support 20 (also referred to herein as a backing) and impinges upon the material layer 24 and conveys thereto energy which evaporates a portion of the material layer 24 from the area 48 as best shown in FIGS. 2A and 2B. The transfers work optimally when the laser pulse is strongly absorbed in a shallow region at the interface between the ribbon backing material 20 (e.g., transparent polyester) and the material 24. The laser beam vaporizes a small amount of the material at the interface causing it to be released from the backing 20 and to be driven forward in a mildly percussive event. The material vaporized is generally the organic matrix of binder and precursor, with little or no vaporization of the material of interest.

The material/matrix combination must be nearly opaque at the laser wavelength for the transfer method to be operational. If the material/matrix does not strongly absorb, a small amount of dye or absorbing agent is added. The material on the ribbon furthest from the laser (closest to the substrate 12) may not receive significant laser radiation and may not even experience a significant elevation of temperature.

Typically, the portion 50 of the material deposited onto the substrate 12 in a single laser “shot” does not complete an operation of creating the full microstructure 52 (shown in FIG. 2B in invisible lines). Therefore, to continue formation of the microstructure 52, the process is continued, as shown in FIG. 2C, wherein the laser beam is displaced to perform transfer from a “fresh” area 54 located adjacent to or partially overlapping with the portion 50. Thus, the material is released from the ribbon by means of adjacent or partially overlapping laser pulses. The entire pattern is written by scanning the beam, or the substrate, or both, in a coordinated pattern.

If more material is required than can be transferred in a single scan (called a “pass”), after the original ribbon is removed, a fresh ribbon is applied and the process is repeated. This sequential multiple-ribbon stacking technique is used for transfers to ensure enough material is deposited and that holes, gaps, and defects arising in the first pass are “averaged out”. Thus, for impingement onto the non-transferred area 54 of the material covered ribbon 18, the laser beam 44 is displaced from its original position by means of the mirror 38 controlled by the control unit 40.

Alternatively, the position of the substrate 12, may be also changed in the X-Y direction 16 by the control unit 40 through the control channel 56. The system 10 implementing the contact transfer method of the present invention, is capable of changing relative disposition between the laser beam 44 and the substrate 12 either by means of the optical system, i.e., mirror 38, or by changing the position of the substrate 12, or both simultaneously. All displacements are varied in accordance with the command of the control unit 40 which is operationally responsive to data 58 indicative of a microstructure pattern to be created. The control unit 40 further includes a mechanism 60 for controlling positions of the mirror 38 and the substrate 12, and software 62 incorporated therein which makes displacement decision based on the data 58.

The control unit 40 may include a personal computer, which has embedded therein typical design programming product common in the art, which includes a database (data 58) containing coordinates of the structures to be created, and software 62 which “reads” the position of the structure to be created from the data 58, and, responsive thereto, controls mutual disposition between the elements of the technological process. Particularly, with regard to the material transfer technique of the present invention, the software 62 controls the mechanism 60 which displaces either the mirror 38, or the substrate 12, or both simultaneously in a manner that the laser beam 44 is aligned with the coordinates of the structure to be created on the substrate 12.

Specifically, for controlling the position of the laser beam by means of controlling the position of the mirror 38, the mechanism 60 displaces the mirror 38 from its original position which results in the displacement of the laser beam 44. The mechanism 60 may include a system of telescopic members and gears operatively coupled to the mirror 38 for reciprocation and angular articulation of the same under the control of the software 62 (systems similar to the mechanism 60 are well known in the art, and, therefore, the mechanism 60 is not intended to be discussed herein in further detail).

The displacement of the laser beam 44 continues in the same fashion until it is aligned with the coordinates XY of the structure to be created on the substrate 12. Before actuating the laser, care is also taken to align a fresh ribbon with the area of the substrate on which the substrate is to be created, in order that the laser beam 44 which is aligned with the coordinates XY, impinges upon a fresh ribbon for material transfer. For multiple sequential material transfers, the mechanism 60 displaces the mirror 38 after each “shot”, thus causing a responsive displacement of the laser beam 44 until the entire structure is formed.

In order to control the positioning of the substrate 12, the mechanism 60 which is operatively coupled to the stage on which the substrate 12 is positioned, displaces the stage in X-Y directions from its original position in order to align the subject area of the substrate (obtained from the data 58) with the position of the laser beam 44.

In simultaneous displacement of the laser beam 44 and the substrate 12 for executing a relative motion of one with respect to the other, the mechanism 60 is coupled to both the mirror 38 and the substrate 12, for in order to control their mutual disposition.

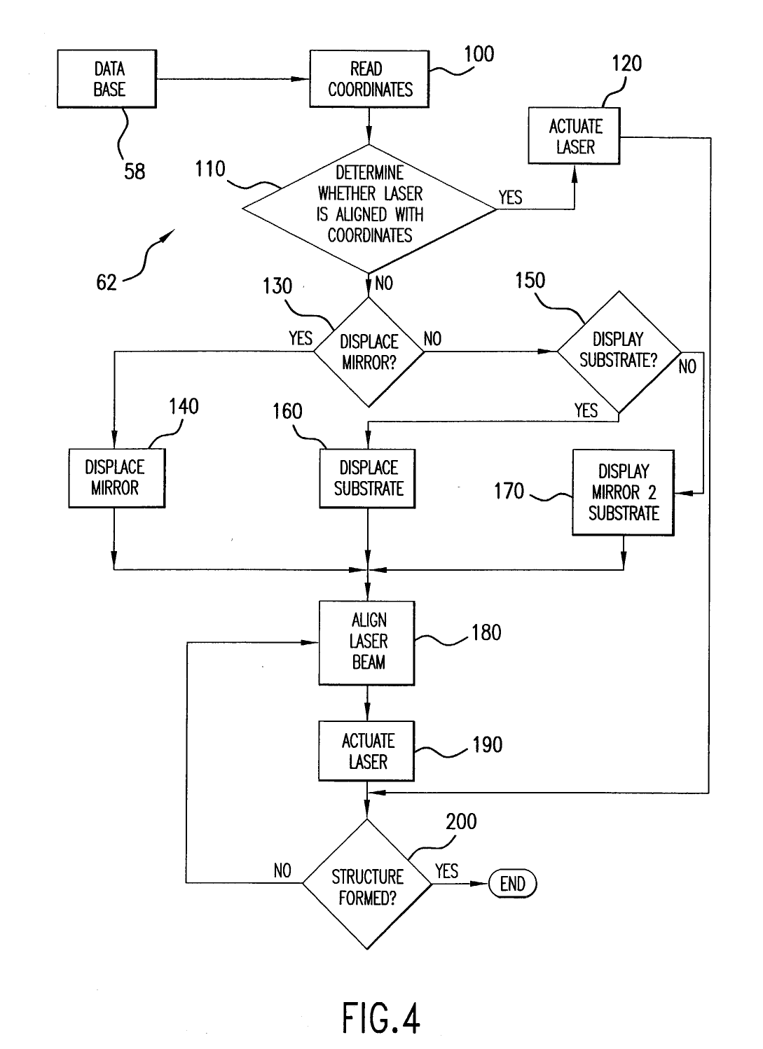

With regard to FIG. 4, defming the flow chart diagram of the software 62 for controlling the relative disposition between the laser beam 44 and the substrate 12 during the transfer process, the software 62, in the block 100, reads the X-Y coordinates of the structure to be formed from the data base 58. From the block 100, the flow chart follows to the logic block 110 “Determine Whether Laser is Aligned with Coordinate”. If the laser is aligned with the coordinate of the structure to be created, the logic flows to the block 120 “Actuate Laser”. If in block 110, the software determines that the laser is not aligned with the coordinate, the logic flows to block 130 “Displace Mirror?”, in which a mode of operation is chosen. Particularly, in block 130, it is determined whether the relative disposition between the laser beam and the substrate will be controlled through displacement of the mirror 38, displacement of the substrate 12, or displacement of the mirror and substrate simultaneously. In this manner, if the displacement is chosen to be accomplished by displacing the mirror, the logic flows from the block 130 to the block 140 “Displace Mirror” so that the mechanism 60 will be operatively coupled to the mirror 38 for displacing the same, and for changing the position of the laser beam thereby.

If it is preferred that the control of the mutual disposition between the laser beam and the substrate is to be performed not by displacing the mirror, the logic follows from the block 130 to block 150 “Displace Substrate?”. If the control of the relative disposition between the laser beam and the substrate is to be conducted through displacing the substrate, the flow chart moves from the block 150 to the block 160 “Displace Substrate”. If, however, it is preferred to control the position of the mirror and the substrate simultaneously, the logic flows from the block 150 to the block 170 “Displace Mirror and Substrate”.

Upon the mode of operation being chosen, and either of blocks 140, 160 or 170 is actuated, the logic flows from the respective blocks (140, 160, or 170) to block 180 “Align Laser Beam”. Once the laser beam is aligned with the X-Y coordinates on the substrate 12, the logic proceeds to block 190 “Actuate Laser”.

When a single “shot” material transfer is performed, the logic requests in block 200 “Structure Formed?”. If the structure is completed, the logic ends the procedure. If, however, in block 200, it is determined that the structure is not completed, and multiple sequential material transfer acts are further needed, the logic loops from the block 200 to the block 180, until the structure is completely formed in block 200. The logic proceeds also from block 120 to block 200, to form a complete structure to be created.

As best shown in FIG. 2D, to continue the formation of the microstructure 52, after the portion 64 of the material layer 24 has been deposited onto the surface 14 of the substrate 12 in adjacent or partially overlapping fashion with the portion 50 of the microstructure 52, the laser beam 44 is displced to the next (adjacent or overlapping) position to complete formation of the microstructure 52. As is seen in FIG. 2D, no edge irregularities occur between the portions 50 and 64 of the microstructure 52 due to sequential material transfers. In this manner, the contact transfer process of the present invention continues until the complete microstructure 52 is formed on the surface 14 of the substrate 12. It is found that multiple sequential material transfers (each of which includes alignment of the unablated material layer 24 with the area on the surface of the substrate, setting the relative disposition between the laser beam and the substrate, and the laser “shots”) may be required for forming a microstructure 52 of sufficient thickness or density.

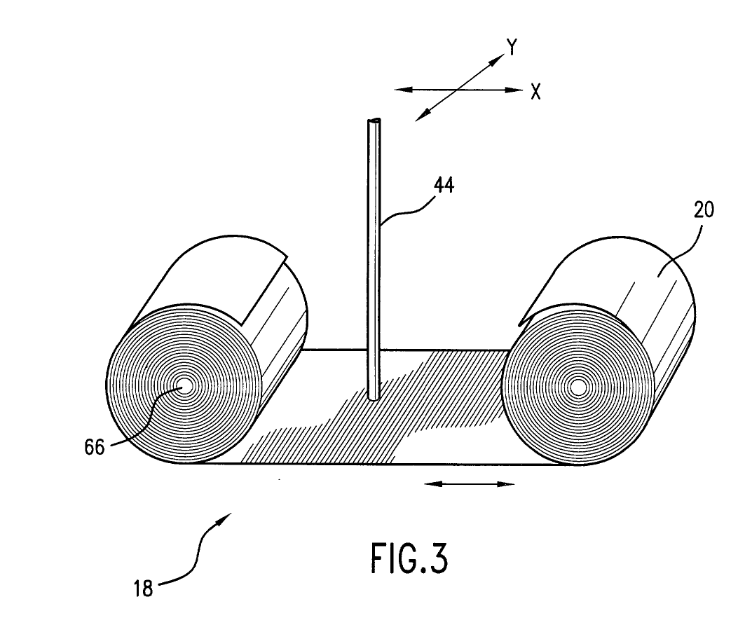

As shown in FIG. 3, a reel-to-reel arrangement that permits application of the ribbon 18, scanning with the laser, followed by lifting the ribbon 18 from the substrate 12, then advancing the used ribbon 18 to the takeup reel 66 to expose fresh ribbon, makes automation of the process possible. It is possible to form the stripes of different materials on the same backing 20 for forming multi-element microstructures. A device such as a vacuum chuck 68, best shown in FIG. 1, whereby a pressure differential from top (higher P) to bottom of the ribbon assures constant and intimate contact with the substrate.

The material of the material layer 24 may be substantially any material to be deposited onto the surface of the substrate 12 to form the microstructure 52 which may be a conductive material, a ceramic, a dielectric, etc. In addition to the requirement of strong absorption at the transfer laser wavelength, it has been found that the thickness of the material layer 24, its uniformity, homogeneity, size distribution of the particles, as well as the cohesiveness of the material layer 24, is of importance in creating defect-free, high resolution, sharp edged microstructures 52.

Particle packing is facilitated when the matrix material passes through a melt phase during the post-transfer baking. Efficient packing of material particles is often important to achieving optimal physical properties, such as conductivity in the case of metals. For example, in order to create silver microstructures 52, the material layer includes silver powder having particles of dimensions 0.1 through 5 microns in diameter bound by a binder in a layer of thickness not exceeding 10 microns. The binder provides a specific cohesiveness to the particles of silver powder.

The backing material is transparent to the transfer laser beam. The ribbon 18 is flexible to conform to the substrate 12 when used with a vacuum chuck 68, best shown in FIG. 1, and permits the ribbon 18 to be rolled for easy storage. Polyester is generally used for backing 20, though other materials may be applicable dependent on the requirements. The thickness of the polyester backing 20 is generally maintained less than 250 μm.

It is important that the material adhere to the backing 20 in order that it doesn't flake off on handling. Conversely, after the material is applied to the backing 20 and dried, it is important that the material does not stick to the flip side of the backing when rolled for storage.

The material layer 24 on the material covered ribbon 18 includes particles of the material to be deposited, precursor materials that convert to a desired material during post-processing (generally heating), and an organic binder matrix. The material is generally dry to the touch (non-sticky) at typical storage temperatures as well as the temperature of the substrate during transfer. The material must not stick to the flip side of the backing layer when rolled, nor should it stick to the substrate until specifically released by the laser.

The coating of the ribbon material is important to the transfer where variations >10% of average thickness significantly affect the transfer characteristics. Pinholes, scratches, agglomerations and dust particles are disadvantageous and are minimized.

The thickness of the material layer on the ribbon has an effect on the lateral resolution of the deposited material. Generally, the thicker the material layer, the poorer the achievable resolution. Thicker material requires greater laser fluence to cleanly release the material. The explosive force can result in cratering of the ribbon with inconsistent volumes of material transferred with each “shot”. Thinner ribbons permit high-resolution transfers with minimum feature size of 10 microns or less. However, thin ribbons may require more scans to achieve a desired material thickness on the substrate. It is found that ribbon material layers in the range of 2 to 15 microns are preferable.

The particles must be small with respect to the desired minimum feature size and uniformly dispersed.

When precursors are used, they generally decompose or chemically convert to a desired species upon heating or irradiation with light. An example precursor is a silver-organic compound, such as silver acetate, that upon heating converts to pure silver and a volatile organic compound. The remaining silver may form a conductor itself and may also help to bind the silver particles that have been deposited.

The binder in the matrix has several functions. It holds the material on the ribbon backing. It also holds the transferred material together to obviate the tendency of dry powders dispersing upon transfer, thus adversely affecting resolution. Further, it is found beneficial that the binder goes through a melt phase during post-transfer heating. Surface tension helps to “pull” the transferred particles together and to “lubricate” their efficient packing. Usually, it is desirable that the binder material is left during post-processing. Thus another requirement for the binder is that it decomposes to a volatile species at a temperature that is compatible with the material, precursor and substrate, or is otherwise converted into a material that adds useful properties.

As shown in FIG. 1, vacuum chuck (˜3-15 psi) holds the ribbon in close contact with the substrate. A gap between the ribbon and substrate as small as a few microns may result in poor feature definition, a loose, porous deposit, and scattered debris. The vacuum chuck, together with a thin, flexible, conforming ribbon permits constant pressure across the substrate surface and contiguous contact between the ribbon 18 and the substrate 12.

The vacuum chuck 68 may be of a standard design commercially available, such as, for example, model CVC Series Chuck manufactured by PhotoMachining, Inc., Pelham, N.H. The vacuum chuck is specifically directed to providing a constant pressure differential across the ribbon 18. In general, the vacuum chuck has a surface area greater than the substrate to provide a constant or equal pressure differential. Vacuum chuck 68 is provided to insure that there are no bubbles, wrinkles, or other irregularities formed in the ribbon 18. A separation of even 10 microns between the substrate and the ribbon has resulted in diminished resolution and thus, the use of vacuum chuck 68 has been found to be advantageous in the overall system herein defined.

In order to convert the precursor and to remove unwanted traces of byproducts, binder, and organics in the material layer 24, the microstructure 52 is exposed to a baking process which removes substantially all of the unwanted ingredients and leaves on the surface 14 of the substrate 12 only the desired phase, which in this case is silver.

By means of performing multiple (for example, 2-6) material transfers, silver lines of the thickness 4-15 micron can be created from 2-6 micron thick material layer 24.

In addition to providing a viscous property to the material layer 24, in order to make the material softer and less brittle, the substrate and ribbon in contact are heated to a temperature higher than 40° C. (thus improving the quality of the transfer process) by superimposing a continuous IR laser over the UV transfer laser spot (in coaxial overlapping beams manner). The IR laser warms only the areas local to the transfer, thus avoiding material sticking to the substrate in unintended areas.

The distribution of the material powder over the entire area of the material layer 24 is formed as uniformly as possible which is important for a successful contact transfer process of the present invention.

Since the microstructures to be created onto the surface of the substrate 12 are not always of the same size and are not always fine features, i.e., in some cases, the features to be created may be coarse, the process of the present invention permits creation of microstructures of different dimensions by controlling the size and shape of the dynamic aperture 28. The aperture 28 may be made in the form of a wheel, strip or area array which would include different types of apertures of different diameters and different shapes which would structure the laser beam passing therethrough. It is clear that laser beams of different shapes and sizes of cross-section, by impinging onto the material layer 24, will ablate the material from the areas corresponding to the size and shape of the cross-section of the laser beam, which permits different sizes and shapes of microstructures to be created.

An acousto-optic modulator (AOM) 70 external to the laser cavity is used as both a fast shutter for pulse selection synchronized to laser motion as well as a fast variable attenuator. The method of the present invention requires precise location of adjacent and overlapping laser pulses as well as careful control of incident laser fluence. This combination is difficult to achieve if the laser fires at a fixed repetition rate or if the laser is externally triggered at a variable rate. Further, the shutter opening and closing time must be short compared to the time between successive laser pulses. At laser repetition rates above a few kHz, physical moving shutters are not a practical alternative.

After the last deposition pass, the ribbon material 18 is removed from the substrate 12. Frequently, the edges of features, as transferred, show several microns of roughness. This roughness is easily trimmed with the same laser used in the transfer. The material is loosely adhering and easily dispersed (for instance, into a flowing air stream to be carried away) by the laser. It is usually possible to use a laser fluence that is low enough to avoid significant substrate damage yet still efficiently cleans and trims the deposited material.

The flexible variable fluence control by means of the AOM 70 is particularly useful when switching from deposition, to trimming, to micromachining modes, as each may require different delivered laser fluence.

Immediately after deposition, before the substrate is moved, the locations of the deposited features are known precisely. It is possible to automatically generate an outline of the deposited features, offset by the relevant laser beam radius, and to use this offset outline to generate the path of the laser trim. Larger areas may be simply rastered with parallel scans. Thus, the time, complexity and cost of reregistration of an existing pattern in a separate process are avoided.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular locations of elements may be reversed or interposed, all without departing from the spirit or scope of the invention as defmed in the appended Claims.

What is claimed is:

1. A method for creating microstructure pattern on a surface of a substrate by a contact transfer technique, said method comprising the steps of:
(a) positioning a material covered ribbon in close proximity to said surface of said substrate, said material covered ribbon including a transparent layer and a material layer of a predetermined thickness deposited on said transparent layer and sandwiched between said transparent layer and said surface of said substrate, and
(b) directing a laser beam of a predetermined uniform intensity through said transparent layer to said material layer in alignment with a predetermined location at said surface of said substrate, thereby causing release of a portion of said material from said material layer and transfer of said portion of said material onto said surface of said substrate at said predetermined location thereof to form said microstructure pattern.

2. The method of claim 1, further comprising the step of:
(c) replacing said used material covered ribbon with unused material covered ribbon, and repeating said steps (a) and (b) for said unused material covered ribbon.

3. The method of claim 2, further comprising the steps of:
repeating step (c) at least three times.

4. The method of claim 2, wherein said material covered ribbon and said unused material covered ribbon constitute displaced areas on the same material covered ribbon.

5. The method of claim 1, further comprising the step of baking said portion of said material deposited on said surface of said substrate.

6. The method of claim 1, further comprising the step of pre-heating said material layer and said substrate prior to said transferring of said portion of said material.

7. The method of claim 6, further comprising the step of heating said substrate to a temperature exceeding 40° C.

8. The method of claim 1, wherein said transparent layer of said material covered ribbon is a flexible layer transparent to said laser beam.

9. The method of claim 1, wherein said predetermined thickness of said material layer is approximately in the range of 2-15 μm.

10. The method of claim 1, wherein said material layer contains a homogeneously dispersed material.

11. The method of claim 1, wherein said material layer includes particles of dimensions smaller than 10 μm.

12. The method of claim 1, wherein said material layer contains a binder.

13. The method of claim 1, further comprising the step of structuring said laser beam to create the beam of a uniform intensity.

14. The method of claim 1, further comprising the step of:
transferring said substrate in X-Y directions.

15. The method of claim 1, further comprising the step of:
scanning the laser beam over said surface of said substrate.

16. The method of claim 2, wherein in said step (c), the laser beam impinges upon said material layer of said unused material covered ribbon in adjacent fashion with said portion of said material deposited in said step (b) onto said substrate at said predetermined location.

17. The method of claim 1, wherein said laser beam is generated by a frequency tripled Nd laser.

18. The method of claim 1, wherein said laser beam's wavelength is in the range of 300-400 nm.

19. The method of claim 1, wherein said laser beam is generated by a solid-state diode pumped laser.

20. The method of claim 15, further comprising the step of:
scanning said laser beam by means of at least one galvanometric mirror under computer control.

21. The method of claim 1, further comprising the step of:
directing said laser beam to said material covered ribbon through a variable aperture.

22. The method of claim 4, wherein said material covered ribbon constitutes a reel-to-reel ribbon arrangement, said method further comprising the step of:
in said step (c), lifting said used material covered ribbon from said substrate, and advancing said used material covered ribbon to a take-up reel of said reel-to-reel arrangement to align said unused material covered ribbon with said predetermined location.

23. The method of claim 1, wherein said transparent layer is formed of a polyester composition of a thickness not exceeding 250 μm.

24. The method of claim 1, further comprising the step of upon forming said microstructure pattern in said step (b):
edging features of said microstructure pattern to the desired shape and size with said laser beam.

25. The method of claim 1, further comprising the step of:
providing an acousto-optic modulator external to the laser cavity of a laser generating said laser beam.

26. The method of claim 25, further comprising the step of:
controlling laser fluency by means of said acousto-optic modulator.

27. The method of claim 25, further comprising the step of:
synchronized generating of said laser beam with relative motion between said laser and said substrate by means of said acousto-optic modulator.

28. The method of claim 1, further comprising the step of:
operationally coupling a vacuum chuck to said material covered ribbon and said substrate to create a predetermined pressure across the surface of said substrate for holding said material covered ribbon in contiguous contact with said substrate.

29. The method of claim 6, further comprising the step of:
pre-heating said material and said substrate by a continuous or quasi-continuous infrared laser beam in the areas of said material transfer.
